(19) United States
(12) Patent Application Publication
(10) Pub. No.: US 2016/0189694 A1
(43) Pub. Date: Jun. 30, 2016

(54) SYSTEMS AND METHODS FOR GENERATING PRESENTATION SYSTEM PAGE COMMANDS

(71) Applicant: Richard Lynn Cowan, Auburndale, FL (US)

(72) Inventor: Richard Lynn Cowan, Auburndale, FL (US)

(21) Appl. No.: 14/879,082

(22) Filed: Oct. 8, 2015

Related U.S. Application Data
(60) Provisional application No. 62/061,650, filed on Oct. 8, 2014.

(51) Int. Cl. G10G 1/00

(52) U.S. Cl. CPC G10G 1/00; G10H 2220/011; G10H 2220/015; G10H 2240/211

(57) ABSTRACT

Methods, systems and computer readable media for generating musical score presentation system page commands are described. In some implementations, the method can include receiving an electronic signal corresponding to a music track. The method can also include translating the received electronic signal into a page command. The method can further include generating a page command configured to be provided to an electronic musical score presentation system.

### RELATED APPLICATIONS

This application claims the benefit of U.S. Provisional Application No. 62/061,650, entitled “Systems and Methods for Generating Presentation System Page Commands”, filed on Oct. 8, 2014, which is incorporated herein by reference in its entirety.

### TECHNICAL FIELD

Embodiments relate generally to presentation systems, and more particularly, to methods, systems and computer readable media for generating musical presentation system page commands.

### BACKGROUND

There are presentations systems for musical scores and/or song lyrics. In some conventional presentation systems, changing a display from one page to another page may be performed manually (e.g., by a human operator with a keyboard, mouse or other input device).

Musical score presentation systems, such as that described in U.S. patent application Ser. No. 13/842,874, which is incorporated herein by reference in its entirety, may present one or more portions of a musical score for viewing by vocal or instrumental performers. As used herein, musical score presentation systems can refer to systems that display musical scores, lyrics, or a combination of the two. An accompaniment track (e.g., a stem track or the like) may be played in conjunction with live performances by vocalists and/or instrumentalists. A need may exist to automatically cause the musical score presentation system to display a page of the musical score (or lyrics) in synchronization with the accompaniment track and to cause the musical score presentation system (or lyric presentation system) to automatically advance the page being displayed in synchronization with the accompaniment track.

Embodiments were conceived in light of the above, among other things.

### SUMMARY

Some implementations can include methods, systems and computer readable media for generating musical score presentation system page commands. For example, in some implementations, a method can include receiving an electronic signal corresponding to a music track. The method can also include translating the received electronic signal into a page command. The method can further include generating a page command configured to be provided to an electronic musical score presentation system.

Some implementations can include a method comprising receiving, at a page command generator, an electronic signal corresponding to a music track, and translating, at the page command generator, the received electronic signal into a page command. The method can also include generating, at the page command generator, a page command configured to be provided to an electronic musical score presentation system.

The electronic signal can include a dual tone multi frequency (DTMF) signal. The electronic signal can include a SMPTE time code signal. The method can further include providing the page command to at least one electronic musical score presentation system.

The at least one electronic musical score presentation system can include a first electronic musical score presentation system configured to display a musical score and a second one electronic musical score presentation system configured to display only lyrics.

Some implementations can include a nontransitory computer readable medium having stored thereon software instructions that, when executed by a processor of a page command generator, cause the processor to perform operations. The operations can include receiving an electronic signal corresponding to a music track, and translating the received electronic signal into a page command. The operations can also include generating a page command configured to be provided to an electronic musical score presentation system.

The electronic signal can include a dual tone multi frequency (DTMF) signal. The electronic signal can include a SMPTE time code signal. The operations can further include providing the page command to at least one electronic musical score presentation system.

The at least one electronic musical score presentation system can include a first electronic musical score presentation system configured to display a musical score and a second one electronic musical score presentation system configured to display only lyrics.

Some implementations can include a system having a processor and a data storage device coupled to the processor. The system can also include an input signal detector coupled to the processor, the input signal detector configured to receive an input signal corresponding to a music track. The system can further include a key command generator coupled to the processor, the key command generator configured to generate a page command signal formatted to be recognized by an electronic musical score presentation system.

The processor can be configured to receive data from the input signal detector based on the input signal, and determine a page number of a musical score based on a mapping between the data and the page number of the musical score. The processor can also be configured to provide a page number signal to the key command generator to cause the key command generator to generate a key command sequence configured to cause the electronic musical score presentation system to display a page of a musical score presentation corresponding to the page number of the musical score.

The input signal can include a dual tone multi frequency (DTMF) signal. The input signal can include a SMPTE time code signal. The key command generator can be configured to provide the key command sequence to at least one electronic musical score presentation system.

The at least one electronic musical score presentation system can include a first electronic musical score presentation system configured to display a musical score and a second one electronic musical score presentation system configured to display only lyrics. The key command generator can be configured to provide the key command sequence via a wired interface. The key command generator can be configured to provide the key command sequence via a wireless interface.

### BRIEF DESCRIPTION OF THE DRAWINGS

FIG. 1 is a diagram of an example system and operational environment for providing musical score presentation system page commands in accordance with at least one implementation.

FIG. 2 is a flow chart of an example method for generating musical score presentation system page commands in accordance with at least one implementation.

FIG. 3 is a flow chart of an example method for providing musical score presentation system page commands in accordance with at least one implementation.

FIG. 4 is a flow chart of an example method for providing musical score presentation system page commands in accordance with at least one implementation.

FIG. 5 is a diagram of an example computer system for providing musical score presentation system page commands in accordance with at least one implementation.

FIG. 6 is a diagram of an example computer system for providing musical score presentation system page commands in accordance with at least one implementation.

### DETAILED DESCRIPTION

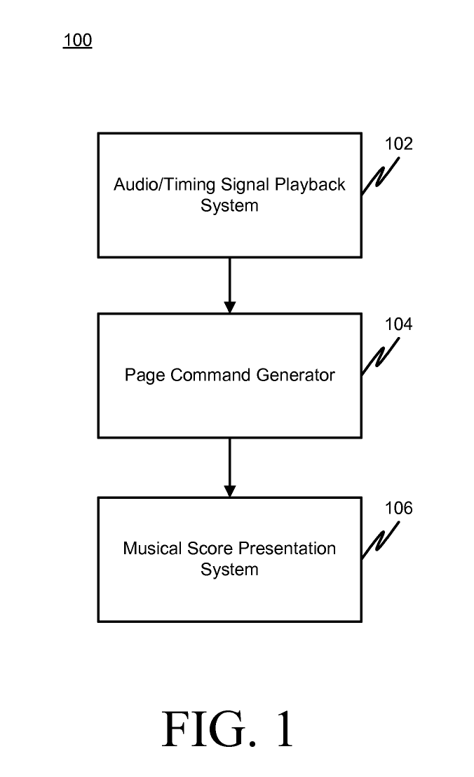

FIG. 1 is a diagram of an example system and operational environment for providing musical score presentation system page commands in accordance with at least one implementation. Environment 100 includes an audio/timing signal playback system 102, a page command generator 104 and a musical presentation system 106.

In operation, the audio/timing signal playback system 102 provides an audio or timing signal to the page command generator 104. The audio signal can include a track of a stem track having one or more sound sources. The audio signal can also be the output of one or more sound sources (e.g., instrumental and/or vocal) either individually or mixed. The timing signal can include a custom timing signal in an un-encoded format or an encoded format (e.g., frequency shift keying or FSK) or a standard timing signal (e.g., SMPTE time code signal, MIDI time code signal, AES/EBU embedded time code signal or the like). The audio/timing signal can also include a track containing audio timing cues in an encoded format (e.g., dual tone multi frequency or DTMF).

The page command generator 104 is configured to receive the audio/timing signal from the audio/timing signal playback system 102. The signal can be received directly through a connected line (e.g., audio line, USB cable, HDMI cable, MIDI cable or the like) or indirectly through a sensor such as a microphone or the like.

The page command generator 104 receives the electronic signal and processes the signal to determine a page code corresponding to the electronic signal, the page code corresponding to a page in a musical score presentation. For example, if the received signal corresponds to a portion of the score that is located on page 4 of the musical score presentation, then the determined corresponding page number command would be the command for page 4. In another example, the audio track could include an encoded page number audio cue (e.g., a DTMF code correspond to digits), which, when received and decoded by the page command generator 104, can be translated by the page command generator 104 into a page command (e.g., a keyboard command sent via USB) to be sent to the musical presentation system 106. For example, the keyboard command could be formatted as one or more keystroke signals that are configured to cause a the musical score presentation system (e.g., a system running PowerPoint or the like) to display a given page of the musical score presentation in response to the keystroke signal (e.g., the keystroke signal includes a keystroke signal or series of keystroke signals configured to cause PowerPoint to display a given page of the musical score presentation). Details of generating and providing page commands are discussed in greater detail below.

It will be appreciated that while a single page command generator is shown in FIG. 1, in some implementations there could be multiple page command generators operating independently in response to separate respective audio/timing signals. In some implementations, the multiple page command generators could be operating from a single audio/timing signal. In other implementations, multiple page command generators could be cascaded together such that one page command generator could be used to provide a signal to a downstream page command generator and so on. In still other implementations, a single page command generator could provide page commands to multiple presentation systems based on a single audio/timing signal such that the presentation systems display pages in synchronization with a same musical score. For example, a single page command generator could send page commands to a first musical score presentation system displaying a musical score to musicians or singers and to a second musical score presentation system displaying lyrics only to an audience or congregation. It will be appreciated that a combination of one or more of the above configurations could be used.

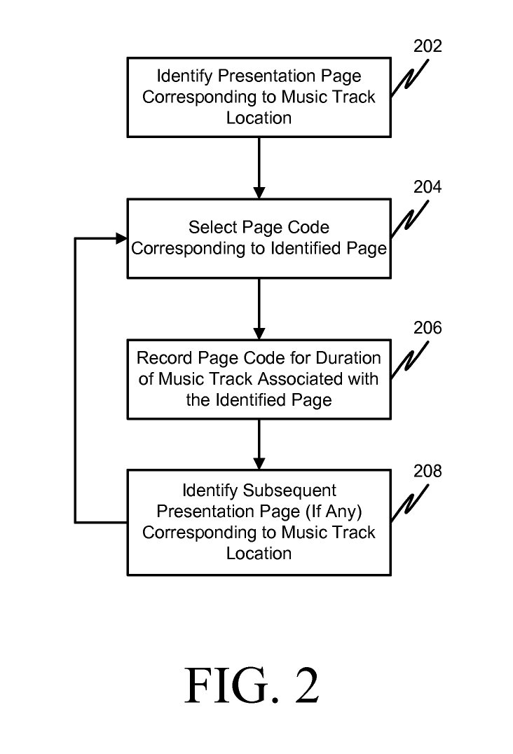

FIG. 2 is a flow chart of an example method for generating musical score presentation system page commands in accordance with at least one implementation. Processing begins at 202, where a presentation page corresponding to a music track location (or time code) is identified. For example, the musical score presentation system could include an output relating the presentation pages to a portion of the musical score and/or accompaniment (or stem) track. In another example, an operator could identify which pages of the musical score presentation correspond to which segments or portions of the score and/or accompaniment (or stem) track. In yet another example, a computer system could optically recognize (e.g., in a manner similar to optical character recognition) the musical score presentation pages (e.g., via music OCR software) and then correlate those pages to an audio track (e.g., accompaniment or stem) or to an electronic presentation of the score itself (e.g., in the format of the Sibelius software or other musical composition or notation software format). Processing continues to 204.

At 204, a page code corresponding to the identified page is selected. For example, there may be a library of audio cues (e.g., DTMF audio clips) corresponding to the numbers 1 to 1,000 (or any suitable range of numbers). The audio cue corresponding to the page number can be automatically selected (e.g., by a page command generating system) or manually selected (e.g., by an operator). In another example, the page code could include a time code (or series of time codes) corresponding to the portion of the audio for the page. In general, the page code could any suitable audio or electronic signal that corresponds to a page number when processed by a page command generator. Processing continues to 206.

At 206, the page code is recorded for the portion (or duration) of the audio track associated with the page. For example, in a DTMF audio cue implementation, the corresponding DTMF code for a page could be recorded as a repeating audio cue for the duration of the portion of the track corresponding to that page. In a time code implementation, the system may record a start/end time code for the duration of the portion associated with the page. Processing continues to 208.

At 208, steps 204-208 are repeated for any subsequent pages in the musical score presentation. It will be appreciated that 202-208 can be repeated in whole or in part in order to accomplish a contemplated page command generation task.

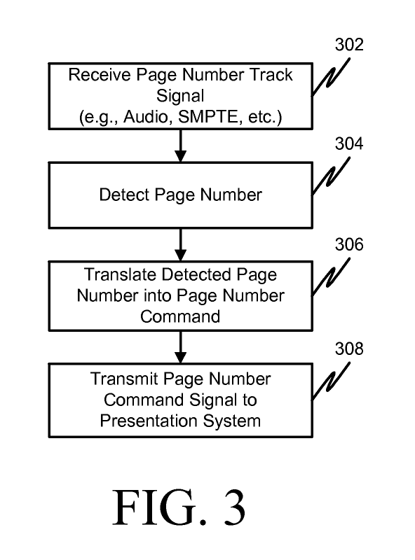

FIG. 3 is a flow chart of an example method for providing musical score presentation system page commands in accordance with at least one implementation. Processing begins at 302, where a page number track or signal is received. For example, an audio cue track with DTMF encoded cues is received at a page command generator (e.g., 104) from an audio source (e.g., 102). Processing continues to 304.

At 304, a page number (encoded or otherwise detectable) in the signal is determined. For example, in a DTMF audio cue signal, the system can include a DTMF decoder to decode the digits represented by the DTMF audio cue. Processing continues to 306.

At 306, the detected page number is translated into a page number command. For example, referring again to the DTMF audio cue example, the digits decoded from the DTMF audio cue can be translated into a page number command (e.g., into signals configured and encoded to be recognized as one or more computer keyboard keystrokes to cause a musical score presentation system to display the presentation page corresponding to the digits of the DTMF audio cue). In general, any suitable page number command encoding scheme could be used. Processing continues to 308.

At 308, the page number command signal is transmitted to a musical score presentation system. For example, the keystroke signals mentioned in step 306 could be sent via a wired (e.g., USB) or wireless interface (e.g., Bluetooth) to the computer of a musical presentation system. It will be appreciated that 302-308 can be repeated in whole or in part in order to accomplish a page command generation task.

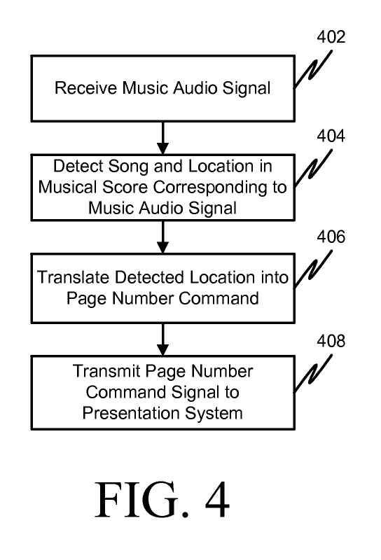

FIG. 4 is a flow chart of an example method for providing musical score presentation system page commands in accordance with at least one implementation. Processing begins at 402, where a music audio signal is received. For example, a page command generator (e.g., 104) is coupled to a microphone that senses audio being played (e.g., instrumental and/or vocal). The page command generator could also have an audio input line coupled to it that is in turn coupled to the audio output of a PA system or mixing board. Processing continues to 404.

At 404, the song and location in the song are determined from the received audio signal. For example, a processor in a page command generator could be configured to analyze the audio pattern (vocal and/or instrumental) and determine the song and current location in the score of the song. Such analysis could be similar to that performed by software applications such as Shazam or Tunatic. In addition to identifying the song, the system may need access to an electronic representation of the score to determine what point in the score corresponds to the music currently being played. A music track signal (e.g., similar to those discussed above) could be used as a signal to validate or augment the automatic song and position determination. Processing continues to 406.

At 406, the detected song and location are translated into a corresponding page number of the musical score presentation, which in turn can be encoded a page number command (e.g., in a manner similar to 306 of FIG. 3 discussed above). Processing continues to 408.

At 408, the page number command is transmitted to the presentation system (e.g., in a manner similar to 308 of FIG. 3 discussed above). It will be appreciated that 402-408 can be repeated in whole or in part in order to accomplish a page command generation task.

The page commands generated by any of the methods or system described herein are not limited to commands for sequential pages. The actual sequence of pages corresponding to the commands can be arbitrary in the sense that a command to turn to a “next” page may actually be a command to jump back to an earlier page. This type of page command could occur for a number of reasons, for example, when a chorus or refrain of a song repeats and returns to a portion of the score and/or lyrics presented earlier.

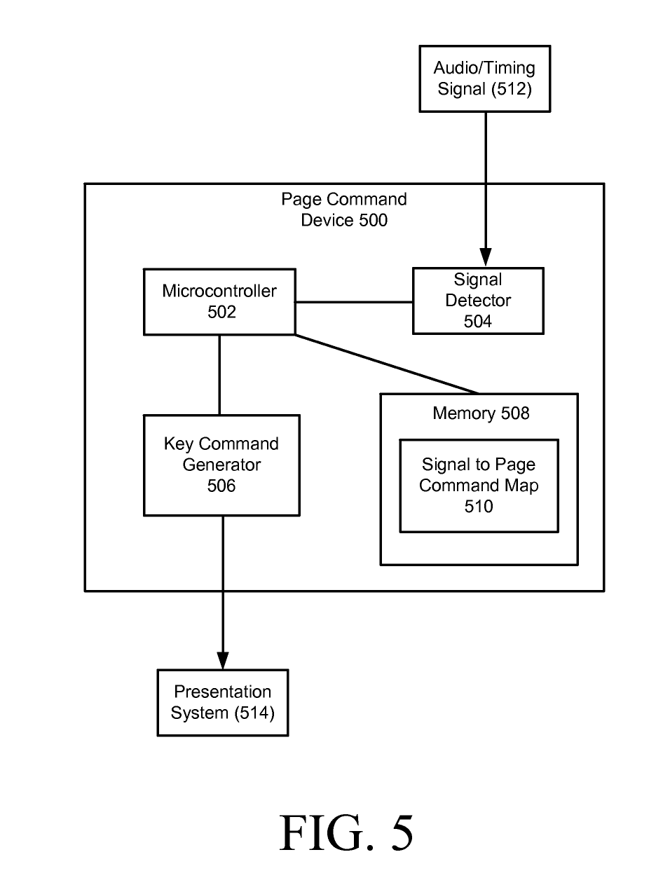

FIG. 5 is a diagram of an example page command generator device (or system) 500 for providing musical score presentation system page commands in accordance with at least one implementation. The device 500 includes a microcontroller 502, a signal detector/decoder 504, a key command generator 506, a memory 508 and a signal to page mapping 510. Also shown are an audio/timing input signal 512 and a presentation system 514.

In operation, the audio timing signal 512 is received by the device 500 at the signal detector 504, which could include a DTMF tone decoder, for example. The signal detector/decoder 504 can transmit data or signals indicating the decoded audio/timing signal to the microcontroller 502. For example, the signal detector 504 could transmit signals or data indicating a decoded DTMF audio cue to the microcontroller 502. The microcontroller can be configured to translate the signal or data from the signal detector 504 into a signal or data (e.g., one or more computer keystrokes to cause the presentation system to display a given page of a score presentation) configured to be sent to the key command generator 506 for transmitting (e.g., via USB keyboard simulation or Bluetooth keyboard simulation) to the presentation system 514.

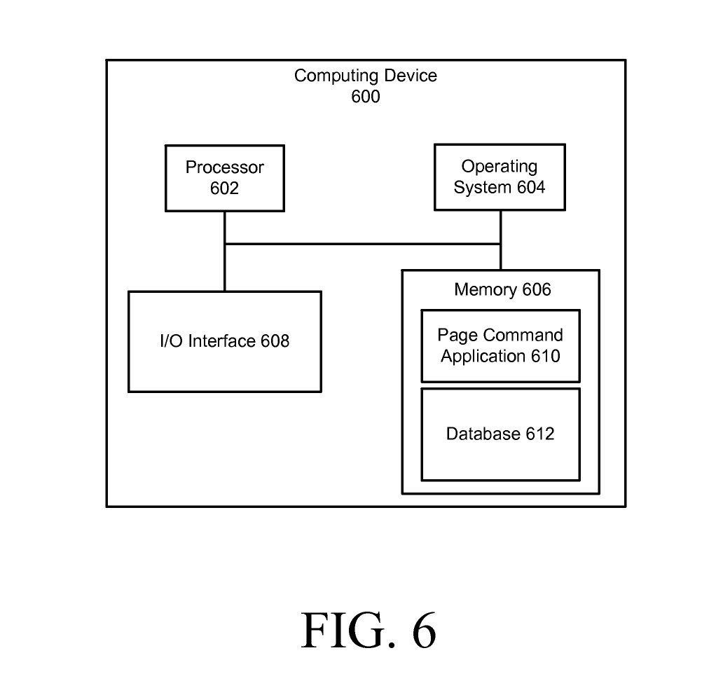

FIG. 6 is a diagram of an example computer system 600 (e.g., a computer system in an audio performance system, a mixing board, an electronic musical score presentation system or the like) in accordance with at least one implementation. The computer 600 includes a processor 602, operating system 604, memory 606 and I/O interface 608. The memory 606 can include a musical score presentation system page command application 610 and a database 612 (e.g., for storing music track location to presentation page number mappings or the like).

In operation, the processor 602 may execute the application 610 stored in the memory 606. The application 610 can include software instructions that, when executed by the processor, cause the processor to perform operations for providing musical score presentation system page commands in accordance with the present disclosure (e.g., performing one or more of steps 102-106, 202-208, 302-308, and/or 402-408 described above).

The application program 410 can operate in conjunction with the database 412 and the operating system 404.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable arts from the function description provided herein and with a general basic knowledge of the software engineering and music production and performance arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for generating musical score presentation system page commands.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method comprising:
receiving, at a page command generator, an electronic signal corresponding to a music track;
translating, at the page command generator, the received electronic signal into a page command; and
generating, at the page command generator, a page command configured to be provided to an electronic musical score presentation system.

2. The method of claim 1, wherein the electronic signal includes a dual tone multi frequency (DTMF) signal.

3. The method of claim 1, wherein the electronic signal includes a SMPTE time code signal.

4. The method of claim 1, further comprising providing the page command to at least one electronic musical score presentation system.

5. The method of claim 4, wherein the at least one electronic musical score presentation system includes a first electronic musical score presentation system configured to display a musical score and a second one electronic musical score presentation system configured to display only lyrics.

6. A nontransitory computer readable medium having stored thereon software instructions that, when executed by a processor of a page command generator, cause the processor to perform operations including:
receiving an electronic signal corresponding to a music track;
translating the received electronic signal into a page command; and
generating a page command configured to be provided to an electronic musical score presentation system.

7. The nontransitory computer readable medium of claim 6, wherein the electronic signal includes a dual tone multi frequency (DTMF) signal.

8. The nontransitory computer readable medium of claim 6, wherein the electronic signal includes a SMPTE time code signal.

9. The nontransitory computer readable medium of claim 6, further comprising providing the page command to at least one electronic musical score presentation system.

10. The nontransitory computer readable medium of claim 9, wherein the at least one electronic musical score presentation system includes a first electronic musical score presentation system configured to display a musical score and a second one electronic musical score presentation system configured to display only lyrics.

11. A system comprising:
a processor;
a data storage coupled to the processor;
an input signal detector coupled to the processor, the input signal detector configured to receive an input signal corresponding to a music track; and
a key command generator coupled to the processor, the key command generator configured to generate a page command signal formatted to be recognized by an electronic musical score presentation system,
wherein the processor is configured to:
receive data from the input signal detector based on the input signal;
determine a page number of a musical score based on a mapping between the data and the page number of the musical score; and
provide a page number signal to the key command generator to cause the key command generator to generate a key command sequence configured to cause the electronic musical score presentation system to display a page of a musical score presentation corresponding to the page number of the musical score.

12. The system of claim 11, wherein the input signal includes a dual tone multi frequency (DTMF) signal.

13. The system of claim 11, wherein the input signal includes a SMPTE time code signal.

14. The system of claim 11, wherein the key command generator is configured to provide the key command sequence to at least one electronic musical score presentation system.

15. The system of claim 14, wherein the at least one electronic musical score presentation system includes a first electronic musical score presentation system configured to display a musical score and a second one electronic musical score presentation system configured to display only lyrics.

16. The system of claim 11, wherein the key command generator is configured to provide the key command sequence via a wired interface.

17. The system of claim 11, wherein the key command generator is configured to provide the key command sequence via a wireless interface.
